(19) United States
(12) Patent Application Publication
(10) Pub. No.: US 2002/0184162 A1
(43) Pub. Date: Dec. 5, 2002

(54) Method and system to facilitate distribution of services and resources through a network

(76) Inventors: Aliaksandr Babitski, Toronto (CA); Serge Chernyavsky, Toronto (CA); Tatiana Outkina, Toronto (CA); Robert Purdy, Toronto (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 09/870,636

(22) Filed: Jun. 1, 2001

(51) Int. Cl. G06F 17/60

(52) U.S. Cl. 705/67

(57) ABSTRACT

Services and resources hosted by more than one originator are distributed to a plurality of consumers. To facilitate the distribution of the services and resources, the reseller contains host access information for each originator to which the reseller is authorized to access resources. Upon receipt of consumer access information to an authorized consumer, the reseller provides host access information to each originator hosting resources the authorized consumer is authorized to access. Each originator receiving host access information from the reseller will permit the authorized consumer access to the resources and services. In this way, a reseller provides a “virtual host” to consumers by reselling services and resources from different originators. An originator may also be a reseller of those services and resources of other originators. The originators and resellers are identified by unique randomly created identifiers to maintain their identities confidential. Each originator stores information correlating the consumers with the resellers through which the consumer obtains the services of the originator. In this way, the originator can deny access to a reseller, as well as all consumers accessing services through the unauthorized reseller.

### FIELD OF THE INVENTION

This invention relates to the field of distributed computing and distribution of services and resources. More particularly, this invention relates to a method and system to facilitate distribution of services and resources through a network.

### BACKGROUND OF THE INVENTION

It is known in the art to have various originators which host services and resources for use by consumers. It is also known to have originators which physically possess the systems to host services and resources and distribute and sell these services and resources through a network to various remotely located consumers. The consumers purchase these services and resources as required.

The originators can host any number of different services and resources. In a particular case where the originator hosts services for Internet customers, these services and resources would include computer processing space, disk space, IP addresses, web servers, database servers, file servers, connections to backbones and other types of services and resources. In this case, the consumer would generally be a web site owner and would purchase the hosted resources and services as required to operate its web site.

FIG. 1 shows a conventional system 8 for distributing resources and services S over a network I. As illustrated in FIG. 1, the originator 2 provides resources and services, shown generally by reference numerals S1, S2, S3, and collectively by reference numeral S. These services and resources S can be purchased and used directly by consumers 6, such as consumer 6A. In addition to consumer 6A purchasing and using the services and resources S1, S2, S3 directly from the originator 2, resellers 4 may purchase use of the services and resources S from the originator 2 for resale to other consumers 6. For example, in FIG. 1, the reseller 4A has purchased use of services S1, S2 and the reseller 4B has purchased use of services S1, S3. The reseller 4A can then resell these services S1, S2 to consumers 6B to 6D and resellers 4B can then resell these services S1, S3 to consumers 6E and 6F.

Furthermore, in the conventional system 8, the identity of the originator 2 actually hosting the services and resources may be known to all of the consumers 6, including consumers 6B to 6D, 6E and 6F accessing the resources and services through resellers 4A, 4B.

While the conventional system 8 has worked well in the past, the conventional system 8 suffers from several disadvantages. For example, the conventional system 8 suffers from the disadvantage that it has a limited scope. This is the case, in part, because all of the services and resources S accessed by the consumer 6 in the conventional system 8 can originate from only one originator 2. In other words, consumers 6 are limited in their ability to simultaneously access services and resources S hosted by a number of different originators 2.

The conventional system 8 also suffers from the disadvantage that the resellers 4 are captive in that they can only resell services and resources S from the one originator 2. This limits the resellers 4 to purchasing the services and resources S from only one originator 2. This also gives the originator 2 an unfair business advantage. For example, the originator 2 could sell one of the services and resources S1, S2, S3 at a higher price, or, force the resellers 4 to purchase services and resources S which the resellers 4 may not require. Furthermore, the resellers 4 generally are precluded from hosting services and resources S independently and combining these with the services and resources S from other originators 2.

A further disadvantage of the conventional system 8 is that the consumers 6 can only access services and resources S ultimately hosted by one originator 2. In this way, the consumer 6 may be precluded from obtaining a desired combination of services and resources S, if the desired combination of services and resources S are not all offered by the same originator 2. Furthermore, the consumers as illustrated in FIG. 1, for example, are precluded from having services S other than services S1, S2 and S3 because originator 2, from whom the consumers 6 ultimately obtain their services, only provides services S1, S2 and S3.

### SUMMARY OF THE INVENTION

Accordingly, it is an object of this invention to at least partially overcome the disadvantages of the prior art. Also, it is an object of this invention to provide an improved type of system and method to facilitate distribution of services and resources through a network. Furthermore, it is an object of this invention to provide an improved system and device which increases the versatility of the distribution of services and resources through the network.

Accordingly, in one of its objects, the present invention resides in a system for facilitating access by a plurality of consumers to services hosted on more than one originator, said system comprising: in each originator, a host record storing host access information HAI for each consumer authorized to access a service hosted by the originator; in a reseller for reselling services hosted by more than one originator, said reseller containing a reseller record storing host access information for each originator from which the reseller is authorized to access services, and, consumer access information for each consumer authorized to access services provided through the reseller; wherein, in response to the reseller receiving information from an authorized consumer corresponding to the consumer access information for the authorized consumer, the reseller provides host access information from its reseller records to each originator hosting services the authorized consumer is authorized to access; and wherein each originator receiving the host access information permits the authorized consumer access to the services for which the host access information received from the reseller corresponds with host access information stored in the host record of the originator.

In a further aspect, the present invention resides in a method for facilitating access by a plurality of consumers to services hosted on more than one originator, said method comprising the steps of: (a) for each originator, providing a host record storing host access information for each consumer authorized to access a service hosted by the originator; (b) at a reseller, determining which services an authorized consumer is authorized to access; and (c) sending host access information from the reseller to each originator hosting services the authorized consumer is authorized to access.

One advantage of the present invention is that services and resources which may originate from a number of originators, and hosted by a number of different hosting systems, can be accessed, purchased and used by any number of resellers and consumers. In this way, it is possible for a reseller to purchase the use of services and resources from a number of different originators and then resell those resources and services to other consumers. A further advantage of the present invention is that the resellers can also act as originators by hosting services and resources, as well as reselling the services and resources from other originators. A further advantage of the present invention is that resellers can also resell the services and resources to other resellers, thereby permitting resellers to buy the use of a large quantity of hosted applications, from one or more originators, for later resale to a number of smaller resellers.

A further advantage of the present invention is that it provides the ability to bill the consumers of the services and resources for the services and resources which the consumers use. This billing can then be distributed amongst the various resellers and ultimately to the originator hosting the billed services and resources.

A further advantage of the present invention is that it provides confidentiality between the various levels of originators, resellers and consumers. In other words, it is not necessary that the originator know all of the entities between the originator and the ultimate consumer of the services. Rather, the originators only need know the immediate purchaser of the services and resources.

Another advantage of the present invention is that access to services and resources can be discontinued by any one entity. In other words, should an entity choose to discontinue access to services and resources which it provides, whether or not the entity is an originator, reseller, or combination of an originator and reseller, the entity can do so independently. In this event, it is understood that the entity would discontinue the access to services and resources of all other entities which obtain the services and resources through it, even if the other entities do not do so directly.

A still further advantage of the present invention is that it provides the ability to create a liquid market for services and resources. In other words, by providing resellers and consumers with the ability to access, purchase, use and/or resell the services and resources from a number of different originators, the resources and services can then be accessed, sold, used and/or distributed in the network, similar to any other commodity and without restriction as to the originator of the services and resources.

A still further advantage of the present invention is that in a preferred embodiment, the host systems or hosting machines are identified by a unique address on the network. For example, if the present invention is implemented on the Internet, each host system or hosting machines may have an Internet protocol (IP) address. In this way, the host machines can be addressed directly to more efficiently permit transfer of information to and from the host systems and machines.

Further aspects of the invention will become apparent upon reading the following detailed description and drawings which illustrate the invention and preferred embodiments of the invention.

### BRIEF DESCRIPTION OF THE DRAWINGS

In the drawings, which illustrate embodiments of the invention:

FIG. 1 is a schematic diagram illustrating a conventional system.

FIG. 2 is a schematic diagram illustrating an example of the system according to one embodiment of the present invention.

FIG. 3 is a schematic diagram illustrating a selection of consumers shown in FIG. 2 administering their services on corresponding originators.

FIG. 4 is a block diagram illustrating the records stored within originators and resellers according to one embodiment of the present invention.

FIGS. 5A and 5B illustrate the records stored in originator A of the example shown in FIG. 2 and according to one embodiment of the present invention.

FIGS. 6A and 6B illustrate the records stored in originator D of the example shown in FIG. 2 and according to one embodiment of the present invention.

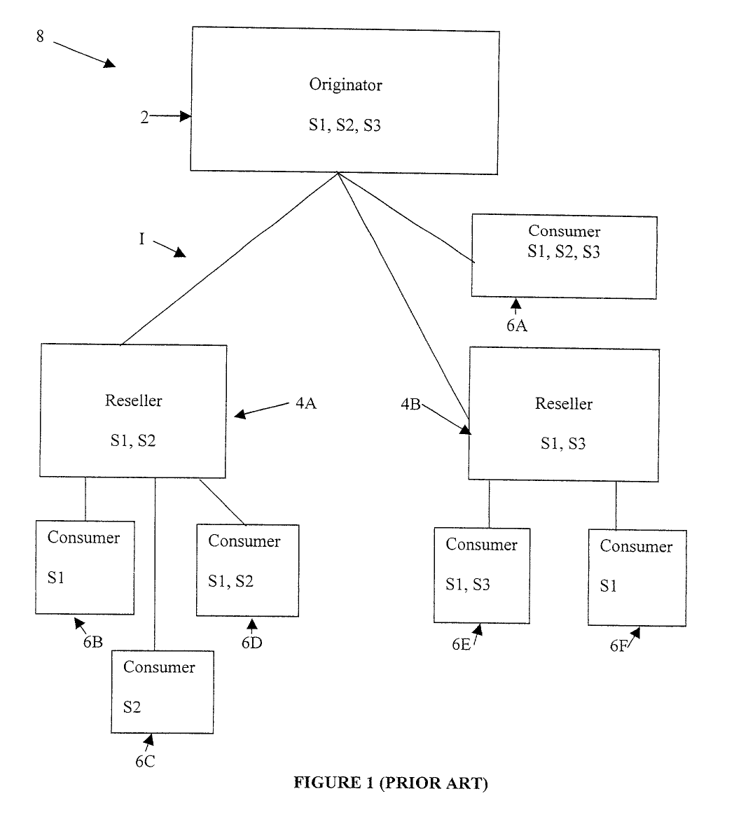

### DETAILED DESCRIPTION OF THE PREFERRED EMBODIMENTS

In one embodiment, the present invention provides a system and method which facilitates an originator of some services, reselling services and resources hosted by other originators. In this way, the system and method according to the present invention provides a single “virtual host” or “virtual originator” which may comprise services and resources hosted by a number of individual and separately located originators, but administered by one consumer, such as a web administrator. This permits a consumer, such as a web administrator, to administer services and resources provided by more than one actual originator.

The present invention also provides the ability for a number of resellers to resell the services and resources from different originators. In other words, the resellers can become a “virtual host” or “virtual originator” providing to a consumer the services and resources being hosted by a number of different originators. It is apparent that the consumer need not be aware that the “virtual host” is not the real host of all the services and resources. In this way, the system and method supports a value added reseller (VAR) structure where a number of resellers can purchase large volumes of services and resources from various originators and then resell the services and resources to either consumers, or other resellers.

To facilitate this VAR structure, the present invention provides a system and method wherein each of the originators and resellers contain records indicating the volume of services and resources having been purchased by the corresponding reseller and/or available by a corresponding originator, and an indication of the further reseller or consumer to whom these services and resources have been resold. These records can be contained within a directory in each originator and each reseller along with the passwords and access information, such as operating accounts, to permit an authorized consumer to access the services and resources. In a preferred embodiment, logs are also kept regarding the usage of each consumer in order to assess billing of the consumer, as well as the resellers, within the VAR structure.

In a further preferred embodiment, the records stored in each database identifying the various resellers and originators are randomly generated, such as by a Globally Unique Identifier (GUID), and can be used to identify the ultimate originator hosting the services and resources and the ultimate consumer to whom the resources have been sold and resold. In this way, confidentiality amongst the various entities in the VAR structure is maintained. Furthermore, encryption is utilized for all communication between the entities within the VAR structure.

In a further preferred embodiment, the consumers are virtual administrators, which is a term used to refer to persons from hosting client companies, typically web site owners, that are responsible for the web site maintenance of a particular web site. Virtual administrators are given enough rights to perform functions asked of them, such as administering the web site of their clients, but not so much access that the security of the system, or other web sites hosted on the system, might be exposed. One system and method for controlling the access of virtual administrators to the system resources, and in particular restricting access of each virtual administrator to the services and resources they are administering on behalf of their clients, is disclosed in co-pending U.S. application Ser. No. 09/631,700 by Chernyavsky et al. entitled “Method and System for Facilitating Remote Administration of Web Sites”, which is assigned to the present applicant and the contents of which is hereby incorporated by reference. It is understood that, while in a preferred embodiment the consumers and administrators in the present system may be virtual administrators as disclosed in U.S. application Ser. No. 09/631,700, it is not necessary in the present system for the consumers and administrators to also be virtual administrators or utilize the system and method described in this application.

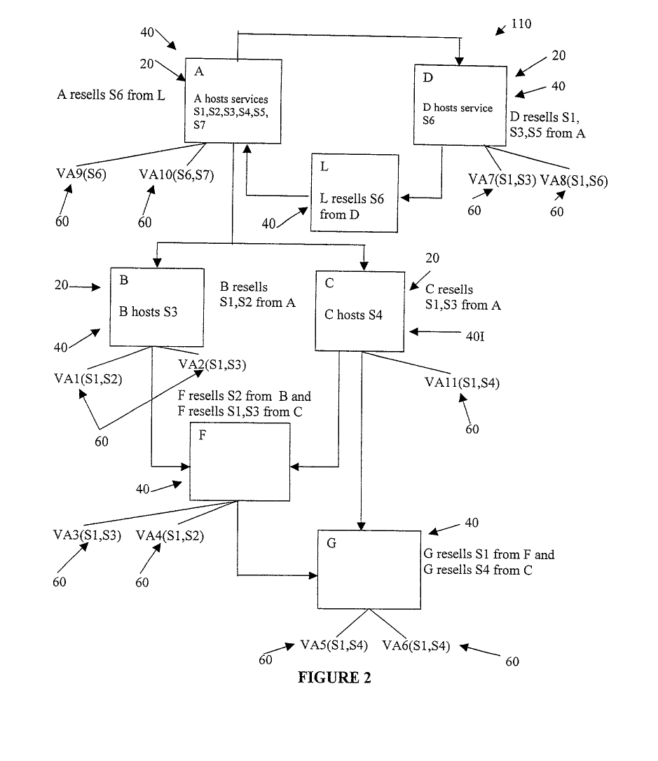

FIG. 2 shows a system, illustrated generally by reference numeral 110, according to an embodiment of the present invention. As illustrated in FIG. 2, the system 110 comprises originator A which hosts services S1, S2, S3, S4, S5 and S7, and, originator D which hosts service S6. The system 110 also comprises originator B which hosts service S3 and originator C which hosts service S4. The services S3, S4 hosted by originators B and C, respectively, may be similar to the services S3, S4 hosted by originator A.

It is understood that reference to the services S in the context of this specification is interchangeable with reference to resources. In other words, throughout this application, including in the claims, reference to services or resources should be considered to include both services and resources.

Entities F and G are resellers 40 in that they resell the services of others. For example, reseller F resells service S2 from originator B and resells services S1 and S3 from originator C. Likewise, reseller L resells service S6 from D and reseller G resells services S1 from F and service S4 from C.

It is also apparent from FIG. 2 that, in the example illustrated in FIG. 2, all of the originators 20 also act as resellers 40 in that they resell services S hosted by other originators 20. For instance, originator A, in addition to hosting services S1, S2, S3, S4, S5 and S7, also resells service S6 from L. Likewise, originator D, while hosting service S6, also resells service S1, S3 and S5 from A. It should be noted from FIG. 2 that reseller L resells service S6 from D to A.

Likewise, originator B, which hosts service S3, also resells services S1 and S2 from A. Similarly, originator C, which hosts services S4, also resells services S1 and S3 from originator A. It is understood that while the present invention facilitates the originators 20 also acting as resellers 40 reselling the services of others, it is not necessary that each or any originator 20 also act as a reseller 40 for the invention to operate.

FIG. 2 illustrates the consumers 60 using services S hosted by the originators 20. The services S which the consumers 60 are authorized to use are shown in brackets. The specific consumers 60 are identified by reference symbols VA1 to VA11. Reference symbol “VA” is used to indicate that the consumers 60 are virtual administrators, as described above. However, as also described above, it is understood that the consumers 60 need not be “virtual administrators”, but rather any type of administrator could be used.

As illustrated in FIG. 2, the consumer 60 can obtain the services S from a number of different originators 20. For example, originator C hosts services S4 and provides this service to consumer VA11. However, originator C resells services S1 from originator A. In this case, service S4 is provided through originator C to consumer VA11.

As illustrated in FIG. 2, reseller F only resells services S1, S2, S3 and does not host any services S. Services S, S3 are provided through reseller F to consumer VA3. The services S1, S3 are resold by F from originator C. Originator C in turn only hosts service S4 and in fact, resells services S1, S3 from originator A. In this case, originator C is acting as an intermediary reseller 40I in that originator C resells services S1, S3 from originator A to reseller F and reseller F then resells the services S1, S3 to consumer VA4.

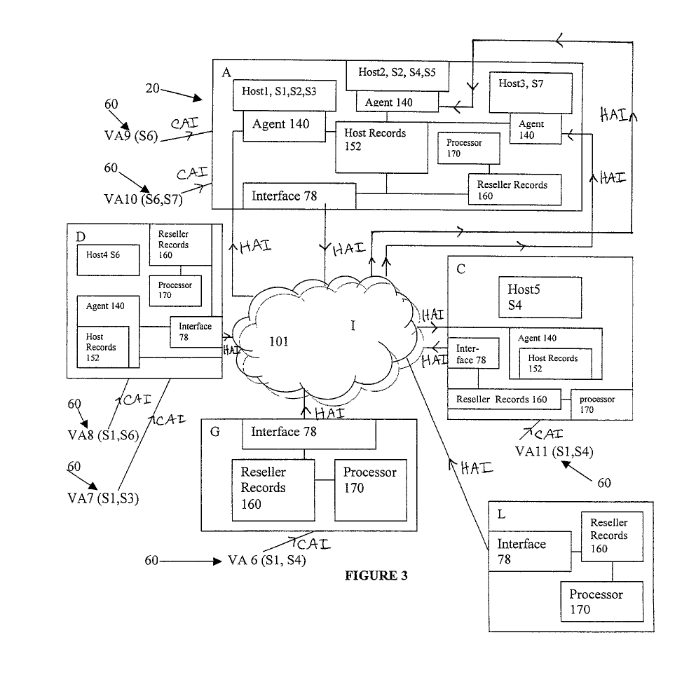

FIG. 3 illustrates connections by selected consumers VA6, VA7, VA8, VA9, VA10 and VA11, shown in FIG. 2, to administer their services. For clarity, only a portion of the system 110 illustrated in FIG. 2 is reproduced in FIG. 3. Consumer VA6 will be discussed first.

Consumer VA6 is authorized to access services S1, S4. Services S1 and S4 are hosted by originator A and originator C, respectively. As illustrated in FIG. 3, originator A comprises Host1 for hosting services S1, S2, S3. Originator A also hosts additional services S4, S5 on Host2 and service S7 on Host3. Likewise, originator C is shown having Hosts for hosting service S4.

In order to access the services S, an agent 140 is used. Access to the agent 140 is obtained once the host access information HA1 is received by the agent 140 and compared to corresponding host access information HA1 stored in its host record 152. A host record 152 may be contained in each of the originators A, C and D. The host record 152 may be stored locally at the agent 140 for the corresponding host machine H, as illustrated by originators C and D in FIG. 3. Alternatively, the host record 152 for one or more host machines H can be stored in a central location within an originator 20, as illustrated by originator A in FIG. 3. Preferably, the host record 152 is stored locally at each agent 140 for a host machine H to permit more efficient access to the services S being hosted by the host machine H. However, if an originator 20 has only one host machine H, such as originators C and D, the host record 152 may be stored centrally within the originator 20 without much decrease in efficiency.

Likewise, resellers 40 contain reseller records 160 having stored therein the consumer access information CAI for authorized consumers 60. The reseller records 160 of a reseller 40 may also contain the host access information HAI permitting the consumer 60 to access services S from each of the host machines H which the authorized consumer 60 is authorized to access. Furthermore, as all of the originators A, C and D in FIG. 3 also resell their services S to other resellers or directly to consumers 60, originators A, C and D also have reseller records 160 to store consumer access information CAI of their consumers 60 and host access information HAI to permit their consumers 60 to access host machines H on other originators 20.

It is understood that the host record 152 and reseller records 160 are generally stored in directories (not shown) in each originator 20 or reseller 40. The directories can be any type of directory stored on a storage device and supported by any type of operating system. In one embodiment, Windows 2000 is utilized as part of the operating system in which case the directory may be the active directory supported through Windows 2000. In an alternate embodiment, the directory may be supported through the Microsoft Data Engine.

When consumer VA6 wishes to administer services S1, S4, it will send its consumer access information CAI to its reseller 40, which in this example is reseller G. Reseller G will compare the information received by consumer VA6 with information stored in reseller records 160 contained in reseller G. If consumer VA6 is an authorized consumer 60, the consumer access information CAI received by the reseller G from consumer VA6 will correspond to the consumer access information CAI stored in reseller G.

Once reseller G is satisfied that consumer VA6 has provided the proper consumer access information CAI, such as password and login, reseller G will interface through a network 101 to the originators from which reseller G is authorized to access services for consumer VA6. In this case, reseller G will send host access information HAI, stored in the reseller records 160, through its interface 78, through the network 101 and then to originators A and C which host the services S1, S4 which consumer VA6 is authorized access.

The network 101 may be any type of network, including the Internet I. Once originators A and C receive the host access information HAI from reseller G, originators A and C will determine if the host access information HAI received from reseller G corresponds with the host access information HAI they have stored for consumer VA6. Generally, the host records 152 of originators A and C will contain the host access information HAI which must be received before consumer VA6 can be permitted to access services S1, S4.

If the host access information HAI provided by reseller G corresponds with the host access information HAI stored in originators A and C, originators A and C will provide access to the resources which consumer VA6 is authorized to use. Reseller G will then create a graphical user interface for services S1, S4 so that consumer VA6 may access and/or administer the services S1, S4. In one embodiment, the graphical user interface provided by reseller G will be substantially identical to a graphical user interface reseller G would have provided if reseller G hosted both services S1, S4 locally. In other words, consumer VA6 may not be aware that the services S1, S4 are not hosted by reseller G or that they are indeed hosted by two separate originators 20, namely originator A and originator D.

Consumer VA11 is similar to consumer VA6 in that consumer VA11 also administers services S1, S4. However, consumer VA11 administers its services through originator C. In this case, originator C hosts service S4 and resells service S1 from originator A. Accordingly, originator C acts as both an originator and a reseller in this example.

When consumer VA11 wishes to access and/or administer its services S1 and S4, consumer VA11 will send its consumer access information CAI to originator C. Originator C will compare the consumer access information CAI received from consumer VA11 with the consumer access information CAI it has stored for consumer VA11. If the information received by originator C from consumer VA11 corresponds to the consumer access information CAI stored by originator C, consumer VA11 will be given access to services S hosted by and provided through originator C for consumer VA6. In this way, originator C will be performing a consumer authorization function similar to the function performed by reseller G when consumer VA6 accesses reseller G.

Once originator C is satisfied that consumer VA11 has provided the proper consumer access information CAI, such as password and login, originator C will permit consumer VA11 to access service S4 which originator C hosts locally on machine H5. This may be done in a conventional manner as originator C hosts services S4 locally. However, for other services S, originator C will interface through the network 101 to the originators from which originator C is authorized to access resources and for which consumer VA11 has previously contracted with originator C to provide. In other words, originator C will perform a function similar to reseller G, namely sending host access information HAI from its reseller records 160, through its interface 78, through the network 101 and then to originator A which hosts service S1.

Once originator A receives the host access information HAI from originator C, originator A will determine if the received host access information HAI corresponds with the host access information HAI originator A has stored for consumer VA6. If the received host access information HAI corresponds, originator A will provide access to the services S which consumer VA11 is authorized to use. Originator C will then create a graphical user interface for services S1 and S4 so that consumer VA11 may access and/or administer the services S1, S4. Consumer VA11 may not perceive any differences between services S1 and S4, even though service S4 is hosted locally by originator C, while service S1 is hosted remotely at originator A and provided through originator C.

Similarly, consumers VA8 and VA7 access services through originator D. Originator D also performs the dual function of hosting service S6 on Host4, while also reselling other services, namely reselling services S1, S3 and S5 from originator A.

Consumer VA8 will access and administer services S1 and S6 in a similar manner to that which consumer VA11 accesses services S1 and S4. In other words, consumer VA8 will send its consumer access information CAI to originator D, and originator D will then compare the consumer access information CAI received from consumer VA8 with the consumer access information CAI it has stored for consumer VA8. If consumer VA8 is an authorized consumer 60, the information received by originator D from consumer VA8 will correspond to the consumer access information CAI stored in originator D. Originator D will then create a graphical user interface 78 for services S1 and S6 so that consumer VA8 may access and/or administer the services S1, S6. Consumer VA8 may not be aware that service S6 is being provided locally by originator D, but service S1 is being provided remotely by originator A.

With respect to consumer VA7, consumer VA7 is authorized to use services S1 and S3. Originator D offers neither of these services S1, S3. Accordingly, originator D will provide consumer VA7 with services S1, S3 from originator A. In this case, originator D will be performing the function purely of a reseller 40, similar to reseller G, because originator D does not host either of the services S1, S3 which consumer VA7 is authorized to use, even though originator D hosts services S6 and is therefore generally referred to as originator D.

Consumer VA9 is authorized to use service S6 from originator A. However, originator A does not host service S6. Accordingly, consumer VA9 will access service S6 through originator A, but originator A will obtain service S6 from reseller L. Reseller L obtains the service S6 from originator D, which may be unbeknownst to originator A. Originator A therefore acts also as a reseller for service S6 from reseller L to consumer VA9, in a similar fashion to how reseller G provides services S1 and S4 to consumer VA6. Reseller L, in turn, obtains the service S6 from originator D. Neither consumer VA9 nor originator A may know that service S4 is being hosted by originator D. Rather, consumer VA9 may believe the service S6 is being provided by originator A, and originator A in turn may believe service S6 is being provided by originator L.

Consumer VA10 is authorized to use services S6 and S7. Service S7 is hosted locally by originator A through Host3, in a manner similar to consumer VA11 accessing service S4 locally at originator C. Consumer VA10 will also access service S6 which originator A provides from reseller L, but which is in fact hosted by originator D. Originator A will create a graphical user interface for services S6 and S7 for use by consumer VA10, but consumer VA10 may not know that service S7 is being hosted locally at originator A while service S6 is being hosted by originator D and provided through reseller L.

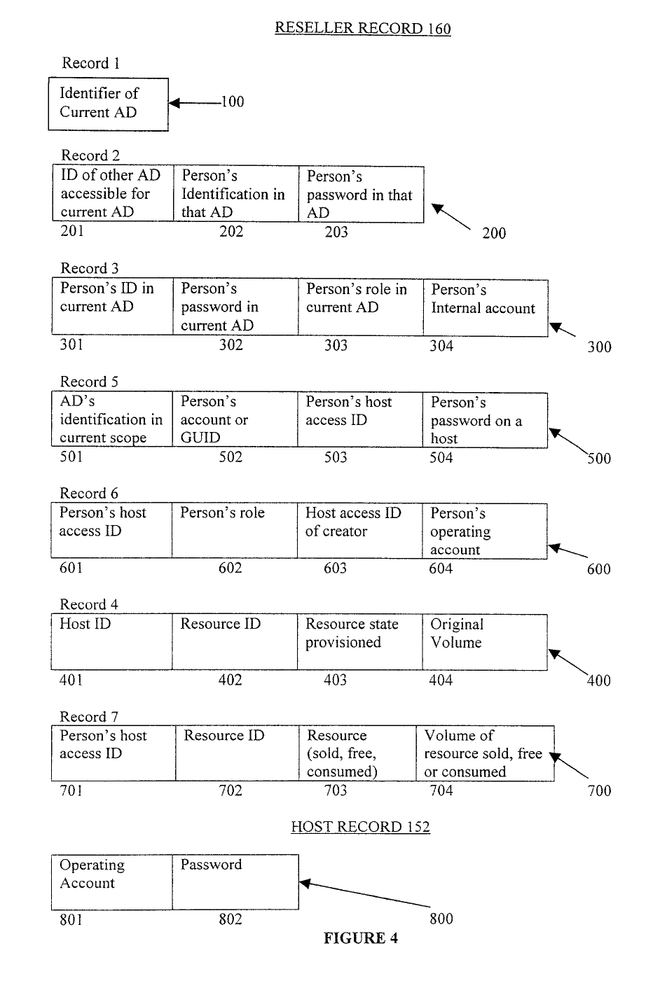

As described above, the information to facilitate sharing of the services S amongst various originators 20 is facilitated by the information stored in reseller records 160 and host records 152 contained within directories of the resellers 40 and originators 20. The specific information stored in these records 152, 160, according to one preferred embodiment of the invention, is illustrated in FIG. 4.

As illustrated in FIG. 4, the first record, namely record 1 identified by reference numeral 100, is “identification of current AD”. This is an identifier for the current entity, namely an originator 20 or a reseller 40 where the reseller record 160 is stored.

The letters “AD” in FIG. 4 is an acronym for “administrative directory”. This identifies the administrative directory of the entity. In a preferred embodiment, the “AD” refers to the administrative directory used in the Windows™ operating systems. However, it is understood that any type of directory could be used in the present invention, and, it is not necessary that the records identify an administrative directory utilized by WindowsT™ operating systems.

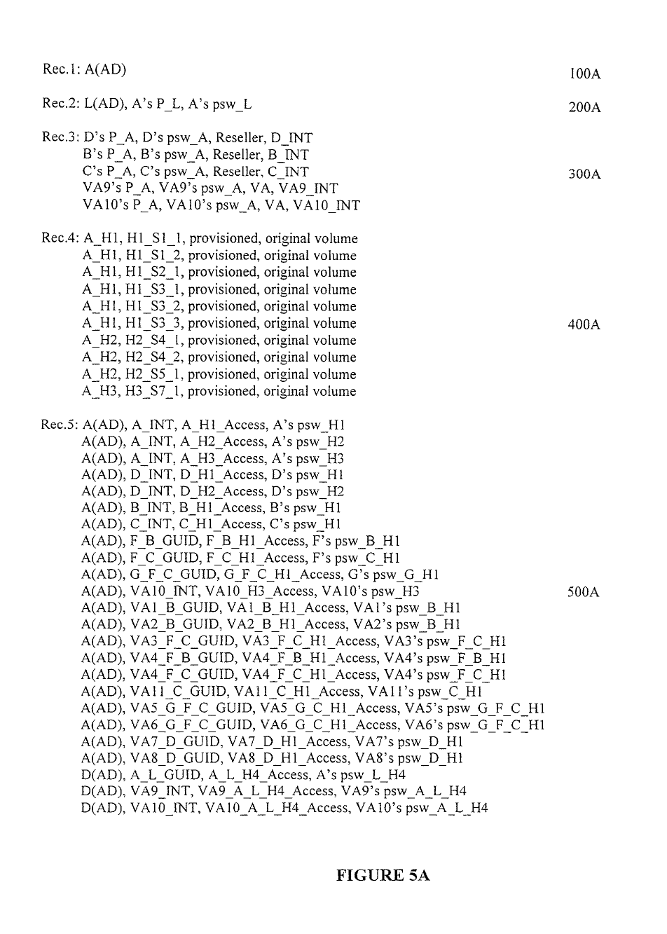

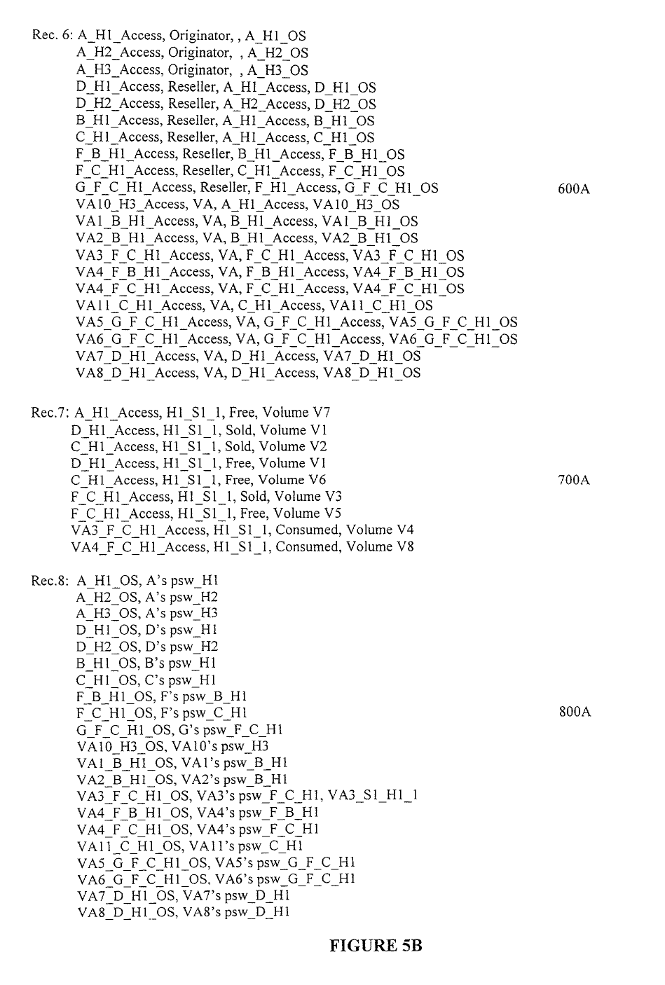

FIGS. 5A and 5B illustrate, symbolically, the nature of the information which may be stored in each of the records for originator A. For record 1, shown by reference numeral 100A in FIG. 5a, the identifier for the current AD 100 is shown as “A(AD)” which represents the identification of the administrative directory for originator A. It is understood that the identifier could be any type of symbol, number or other indicia which can identify an originator 20 or reseller 40.

As shown in FIG. 4, record 2, in one preferred embodiment, comprises three fields, namely (i) “ID of other AD accessible for current AD”, shown by reference numeral 201, (ii) “person's identification in that AD”, shown by reference numeral 202 and (iii) “person's password in that AD”, shown by reference numeral 203. The second record, namely record 2 identified by reference numeral 200 in FIG. 4, identifies the other entities, namely originators 20 or resellers 40, the present entity can directly access. In other words, with reference to FIG. 2, originator A can access services offered by reseller L. Accordingly, for originator A, record 2 will contain information necessary for originator A to access the services from reseller L.

FIG. 5A shows the nature of the information which would be stored in each of the fields 201, 202, 203 for record 2 of originator A. As shown by reference numeral 200A in FIG. 5A, the first field 201 would comprise the identification of the administrative directory for originator L shown symbolically as “L(AD)”. This reflects that originator A has access to the service S6 provided by reseller L as illustrated in FIG. 2. In the second field, the symbol “A's P_L” represents the identifier of originator A in reseller L's reseller record 160. The third symbol in FIG. 5A, namely “A's psw_L”, represents the password of originator A in reseller L's reseller record 160. It is understood that reseller L will have corresponding information in its reseller record 160, but in a different field, to permit comparison and authorization of the information being provided by originator A.

Returning to FIG. 4, in a preferred embodiment, the reseller records 160 contains a third record, namely record 3 which contains information regarding the entities, in this case originators 20, resellers 40 or consumers 60, who can access services S through the present entity. Record 3 comprises four fields, namely (i) “person's ID in current AD”, (ii) “person's password in current AD”, (iii) “person's role in AD”, and (iv) “person's internal account”, identified by reference numerals 301, 302, 303 and 304, respectively.

FIG. 5A illustrates the nature of the information stored in record 3 for originator A, shown generally by reference numeral 300A. The first entry in record 300A contains “D's P_A, D's psw_A, Reseller, D_INT” which represents the information in fields 301, 302, 303 and 304 of record 3 of originator A. Using the same convention as referred to above, the first item, namely “D's P_A”, represents the identifier of originator D in originator A's directory. The second item, namely “D's psw_A”, represents the password of originator D in originator A's directory. The third field 303 in record 3 is shown as “Reseller” which identifies originator D as performing the role of reseller with respect to services S provided by originator A. The fourth field 304 represents the person's internal account, which means the account used internally by the entity. For instance, in FIG. 5A, the internal account number identifying originator D in originator A is represented by “D_INT”.

The last entry of record 3 in FIG. 5A shows the corresponding information for consumer VA10 being “VA10's P-_A, VA10's psw_A, VA, VA10_INT”. This entry for consumer VA10 mirrors the information for originator D in originator A's record 3. In particular, this shows the identifier of consumer VA10 in originator A's directory as “VA10's P_A”, the password of consumer VA10 in originator A's directory “VA10's psw_A”, the role of consumer VA10 with respect to originator A “VA” (which in this embodiment illustrates that consumer VA10 is an administrator or virtual administrator), and consumer VA10's internal account number “VA10_INT”. Accordingly, it is clear that the entry for VA10, which accesses the services S6, S7 from originator A, is similar to the entry for originator D, which accesses services S from originator A for resale, except that the role for consumer VA10 is identified as being an administrator “VA”, while the role for originator D is identified as being a “reseller”.

For consumers 60, fields 301, 302, which contain “person's ID in current AD” and “person's password in AD”, may be used to store the consumer access information CAI which a consumer 60 would need to provide to obtain access to services S. Accordingly, to access services S provided on or through originator A, consumer VA10 would need to provide the consumer access information CAI “VA10's P_A, VA10's psw_A” which would then be compared against the information stored in fields 301 and 302. If the information corresponds, the internal number “VA10_INT” for consumer VA10 in field 304 can be used to identify the services S consumer VA10 is authorized to use.

For resellers 40, fields 301 and 302 provide the information which one originator 20 or reseller 40, such as originator D, would need to provide to communicate with originator A. Similarly, if originator A desires to communicate with another originator 20 or reseller 40, originator A would need to provide corresponding information. For example, in record 2, originator A contains its identifier “A's P_L” in field 202 and password “A's psw_L” in field 203 which originator A must provide to communicate with reseller L. This communication between originators 20 and resellers 40 could be for any purpose, such as creating accounts for consumers 60, administering accounts of consumers 60, obtaining billing information, or even accessing services S for their own use.

Record 5, identified by reference numeral 500 in FIG. 4, contains the information for accessing the services S hosted by originator A and also the services S to which originator A has access. In other words, record 5 contains the information necessary to provide services S hosted by originator A and hosted by other originators, but provided through originator A acting as a reseller.

As illustrated in FIG. 4, the first field 501 referred to as “AD's identification in current scope” identifies the directory of the entity (originator 20 or reseller 40) from which a particular service S is provided. The second field 502 in FIG. 4 is referred to as “person's account or GUID”. This refers to the identifier originator A used to track a person's activity. For entities which are directly associated with originator A, the person's internal account in the present entity, which corresponds to field 304 of record 3, will be used. If the person is not directly associated with originator A, the person will not have an entry in record 3 and will not have an internal account. In this case, the person will be given a GUID number. Preferably, a GUID is used in order to preserve the clients of other resellers confidential.

The third field 503 is the “person's host access ID” which is the information necessary to permit the person to access to the services S. In other words, the third field 503 will contain sufficient information for the software to provide access to hosted services S, or, provide a link to where such information is stored. Finally, the fourth field 504 in FIG. 4 is entitled “person's password on a host” and corresponds to the actual password the person has with the particular host machine, wherever the host machine is located.

With reference to FIG. 5A, record 5 is identified by reference numeral 500A and the fourth entity shows “A(AD), D_INT, D_H1_Access, D's psw_H1” which represents the information stored in the four fields, 501, 502, 503, 504 for originator D's access to host H1. In particular, the first field 501 contains “A(AD)” which identifies originator A where host H1 is located. The second field contains the person's account number. In this case, originator D is directly associated with originator A and this field contains the internal account number for originator D, namely “D_INT”. As originator D is directly associated with originator A, originator D has an internal account number, as also shown at entry 1 of record 3 in the fourth field 504. The next field contains originator D's host access ID “D_H1_Access” and in this case it is the host access ID for originator D to access host H1. The final field contains D's personal password for host H1 at originator A.

Reference is also made to the fourth to last entry in FIG. 5A which states “A(AD), VA8_D_GUID, VA8_D_H1_Access, VA8's psw_D_H1”. This shows customer's VA8 access through originator D to the service S1 on host H1 hosted by originator A. It should be noted that customer VA8 does not have a direct relationship with originator A, but rather purchases the services S through originator D when originator D acts as a reseller. For this reason, consumer VA8 will not have an internal number, but rather has a GUID number, namely “VA8_D_GUID”. The GUID for each entity indirectly associated with originator A will be unique and not used to identify any other entity in originator A. This prevents an ambiguity which could arise if more than one entity in originator A was identified by the same identifier. This also can conceal the true identity of consumer VA8 from originator A, thereby preventing originator A from contacting consumer VA8 directly. However, for monitoring billing and log purposes, originator D may receive a report from originator A showing consumer VA8's access to service S1 identifying consumer VA8 by “VA8_D_GUID” identification. Only originator D will be able to associate the GUID number “VA8_D_GUID” with consumer VA8's true identity.

In the same entry, field 503 contains the host access ID “VA8_D_H1” for consumer VA8 and the field 504 contains the password “VA8's psw_D_H1” for consumer VA8 to host H1. This assists originator A to track the access of consumer VA8 to service S1 on host H1 as described more fully below.

The last entry in record 5 states “D(AD), VA10_A_L_GUID, VA10_A_L_H4_Access, VA10's psw_A_L_H4”. This shows consumer VA10's access through reseller L to the service S6 which is hosted on host H4. The first field 501 of this entry shows “D(AD)” indicating that the host H4 is hosted by originator D. As illustrated in FIGS. 2 and 3, the service S6 is hosted by originator D on host H4. Originator A indirectly obtains access to host H4 through reseller L which in this case acts as an intermediate reseller 40I.

The second field 502 contains the internal number VA10_INT because consumer VA10 accesses its services S through originator A. The internal number “VA10_INT” in field 502 also corresponds to the internal number “VA10_INT” in field 304. Accordingly, the internal number “VA10_INT” can be searched in field 502 to locate all of the services S for which consumer VA10 is permitted access. This is similar to entry 11 in record 5, which contains “A(AD), VA10_INT, VA10_H3_Access, VA10's psw_H3”, which is the information for consumer VA10 to access service S7 hosted on host H3 located within originator A. However, entry 11 in fields 503, 504 contains the information, namely “VA10_H3_Access, VA10's psw_H3”, for accessing services S7 locally on host H3, while the last entry in fields 503, 504 contains the information, namely “VA10_A_L_H4_Access, VA10's psw_A_L_H4” for accessing service S6 on host H4 remotely located in originator D.

Record 6, shown generally by reference numeral 600 in FIG. 4, contains information linking the host access ID with the operating account (“OS”) on a particular host machine which is hosted by originator A. The first field 601 of record 6 contains the “person's host access ID”. This corresponds to the same number stored in field 503 of record 5. The second field 602 in record 6 contains the “person's role”, namely reseller or administrator. The third field 603 contains the host access ID of the creator of the entity referred to in field 601. In this way, field 603 contains an indication of the person who contracted with originator A to provide the services S hosted by originator A. The fourth field 604 contains the “person's operating account” for the particular host H1.

As shown in FIG. 5B, the first line of record 6 for originator A contains the entry “A_H1_Access, Originator, A_H1_OS”. The first field 601 of the first entry states “A_H1_Access” which is the access information for originator A for host H1. In other words, this is the access number for originator A to access its own host H1. The second field 602 contains “Originator” indicating that originator A is acting as originator in its own directory. The third field 603 contains a blank space “ ” because host H1 is located at originator A, and therefore there is no creator. The fourth field 604 contains the symbol “A_H1_OS” which is the operating account of originator A on host H1 permitting originator A to have direct access to host H1.

Reference is also made to the fourth entry of record 6 in FIG. 5B which contains “D_H1_Access, Reseller, A_H1_Access, D_H1_OS”. This entry in record 6 contains information for originator D, which is a reseller, to obtain its operating account “D_H1_OS” to a host H1 giving originator D direct access to host H1. It is interesting to note that the third field 603 shows the creator of this account to be “A_H1_Access” which is the access information of originator A to host H1. Reference is also made to the last entry in record 6 shown in FIG. 5B which is “VA8_D_H1_Access, VA, D_H1_Access, VA8_D_H1_OS”. The first field 601 for consumer VA8, namely “VA8_D_H1_Access”, is an identifier created by originator A to control consumer VA8's access to host H1. The second field 602 identifies consumer VA8 as an administrator. The third field 603 identifies the creator of consumer VA8's account with A as being “D_H1_Access” which is the identifier for originator D to access host H1 in originator A's account. The fourth field 604 contains the operating account of consumer VA8 for host H1.

The operating accounts OS in field 604 for each of the entities is mirrored in the host record 152 shown in FIG. 4 by reference numeral 800. As shown in FIG. 4, the host record 152 contains in the first field 801 the “operating account” which corresponds to the operating account in field 604 of record 6. The second field 802 contains a “password” used by the entity to access the services S. This prevents other entities from inadvertently obtaining the operating account OS and tampering with the entities' services S.

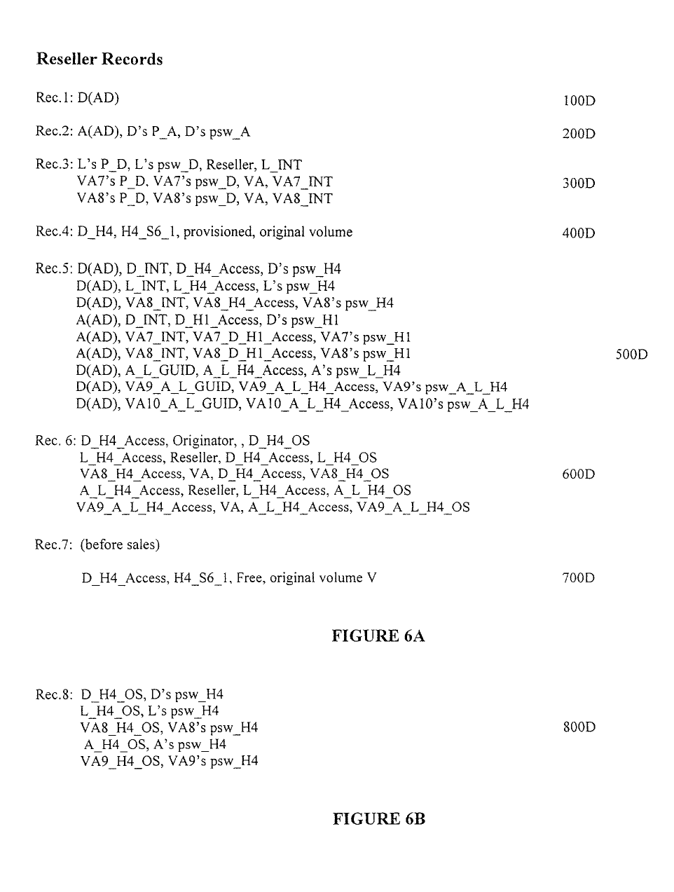

FIG. 6 shows the records in the directory 152 for originator D. As these records mirror the records stored in originator A, they will not be described in detail. However, reference is made to the third entry of record 3, identified by reference numeral 600A in FIG. 6, which shows the entry “VA8's_P_D, VA8's psw_D, VA, VA8_INT” which is the entry in originator D for consumer VA8. It is noted that because consumer VA8 is associated directly with originator D, consumer VA8 will have an entry in record 3 of originator D and will also have an internal number “VA8_INT” in the directory of originator D. Accordingly, when consumer VA8 wishes to access services S hosted by or provided through originator D, consumer VA8 will provide its identifier in originator D's directory “VA8's_P_D” and its password “VA8's psw_D” in originator D's directory. In this embodiment, the identifier “VA8's_P_D” and password “VA8's psw_D” will correspond to the consumer access information CAI referred to above for consumer VA8 to access services S provided by and through originator D.

Assuming that the identifier “VA8's_P_D” and password “VA8's psw_D” provided by consumer VA8 corresponds to that in record 3 of originator D, consumer VA8 will have access to the services S provided by and through originator D. Originator D will then create a virtual host or virtual originator for consumer VA8 comprising the services S1, S6 for which consumer VA8 has been authorized. Originator D will identify services S1, S6 by searching in record 5 field 502 using consumer VA8's internal number “VA8_INT”.

The services S for which consumer VA8 has been contracted is identified in entries 3 and 6 of record 5 in FIG. 6. As shown in FIG. 6, consumer VA8 has access to host H4 which is hosted by originator D (line 3 of record 5) for providing service S6, as well as host H1 in originator A (line 6 of record 5) for providing service S1. Because service S6 is hosted locally on host H4 at originator D, originator D will use the identifier “VA8_H4_Access” stored in field 503 of entry 3 to obtain the operating account of consumer VA8 on host H4 “VA8_H4_OS” contained at line 3 of record 6 for originator D. Likewise, originator D will obtain the password “VA8's psw_H4”, from field 504, entry 3, for consumer VA8 to access host H4. This information, namely “VA8's psw_H4” and “VA8_H4_OS”, will then be provided to the host record 152 for host H4 and to the host part 152 and assuming these numbers correspond to the information stored in records 801 and 802 in record 800D, respectively, consumer VA8 will have access to service S6 on host H4 within originator D.

Entry 6 of record 5 contains information for consumer VA8 to access host H1 on originator A. As field 501 contains “A(AD)” identifying originator A, originator D will be alerted to the fact that consumer VA8 will have access to host H1 on originator A and that originator D must access originator A. Specifically, originator D will obtain the identifier and password for consumer VA8, namely “VA8_H1_Access” and “VA8's psw_H1” contained in fields 503 and 504 of entry 6 in record 500D. Originator D will then provide this information through interface 78 and network I to agent 140 as discussed above with respect to FIG. 3. The information “VA8_H1_Access, VA8's psw_H1” corresponds to the host access information HAI referred to above. This host access information HAI is preferably sent directly to agent 140 for host H1. To accomplish this, agent 140 will have an address in the network 101, such as an IP address if the network 101 is the Internet I, as described above. This address may be embedded in the identifier “VA8_H1_Access”, or embedded in A(AD) stored in field 501 of entry 6 in record 500D, or could be stored in another field (not shown) of the directory in originator D.

In any case, the host access information HAI for consumer VA8, namely “VA8_H1_Access,VA8's psw_H1” will eventually be provided to host record 152 for agent 140 to host H1. This host access information HAI will then be compared to the operating account and password, namely “VA8_D_H1_OS” and “VA8's psw_D_H1” in the last entry of record 800A, and, assuming they correspond, consumer VA8 will have access to host H1. It is understood that having the host access information HAI stored in record 6 is a preferred embodiment and the host access information HAI could be provided by the consumer 60.

If, for whatever reason, originator A decides to discontinue access to originator D, originator A can determine the accounts of originator D using the internal number “D_INT” shown in record 3, line 1, of originator A. With this information, originator A can obtain the identifier of originator D to control access to the originator A's host H1, shown as “D_H1_Access” in record 5 as referred to above. Originator A can then discontinue or delete entries 4 and 5 in record 6 showing “D_H1_Access” and “D_H2_Access”, corresponding to the access ID for originator D.

In addition, originator A will need to delete or discontinue all entities having access through originator D. Originator A can do so by accessing field 603 in record 6 which contains information regarding the creator of a host access ID. In other words, originator A will delete or discontinue the last two entries in record 6 corresponding to consumers VA7 and VA8 because field 603 for these entities shows the creator being “D_H1_Access”.

In a preferred embodiment, field 603 is host specific, meaning that there will be a unique number for each host H to which originator D has access. For example, entry 5 in record 500A contains “A(AD), D_INT, D_H2_Access, D's psw_H2”. Accordingly, field 603 would need to be searched for “D_H2_Access” also in order to discontinue all entities having access through originator D. Alternatively, originator A can discontinue originator D's access to either host H1 or H2.

While the steps taken to delete the entries in records 5 and 4 will prevent originator D, and consumers VA7 and VA8 from administering the services S, it may still be possible for originator D, or consumers VA7 and VA8 to access the agent 140 for host H1 directly and provide the operating account numbers “D_H1_OS”, “D_H2_OS”, “VA7_D_H1_OS” and “VA8_D_H1_OS”, as well as the associated passwords directly to the agent 140. To avoid this possibility, the entries having these operating accounts OS will be identified from record 6 and removed from the host record 152, namely entries 4, 5, 20 and 21 in record 800A.

In this way, originator D, as well as all entities accessing services through originator D, will be deleted from originator A's directory 152. It should be noted that this can all be done locally in originator A's directory 152. In other words, this can be accomplished without access to originator D's directory.

Record 4, shown in FIG. 4 by reference numeral 400, and shown with respect to originator A in FIG. 5A by reference numeral 400A, stores information relating to the volume of services S which can be provided by the originator 20 within which the record 4 is stored. Accordingly, it is clear that record 4 will be empty for a reseller 40, such as reseller G, because a reseller 40 does not host any services S, but only resells services S from other entities. For this reason, record 4 will generally be stored in the host records 152 of an originator 20.

As illustrated in FIG. 5A, record 400A for originator A shows services S1, S2, S3, S4, S5 and S7. The first field 401, referred to as “host ID” in FIG. 4, identifies a host in originator 20. For instance, the first entry of record 4 in FIG. 5A shows “A_H1” which identifies host H1 in originator A.

The second field 402, referred to as “source ID” in FIG. 4, identifies services S reserved for rental or sale. For example, in FIG. 5A, record 4 at the first entry shows “H1_S1_1” which indicates that service S1 is allocated on host H1 in originator A. Because it is possible to have another portion of service S1 on the same host, record 4 identified by reference numeral 400A in FIG. 5A, has the additional number “1” after “S1”. For example, in line 2 of record 4, another portion of service S1 is also hosted by host H1 owned by originator A, as shown by the symbol “H1_S1_2”. The other two fields, referred to as “resource state provisioned”, identified by reference numeral 403 in FIG. 4, and “Original volume”, identified by reference numeral 404 in FIG. 4, simply show the portion of the resource or service S which has been provisioned in the original volume of the resource or service.

Referring to FIG. 4, a further record, namely record 7, identified by reference numeral 700, contains the fields “person's host access ID” 701, “resource ID” 702, “resource (sold, free, consumed)” 703, and “volume of resource sold, free or consumed” 704. Record 7, in combination with record 4, assists originators 20 in following the sale of the services to ensure that not more than the total number of services are sold or consumed.

Initially, before any sales, record 7 for originator A for host H1 and service S1 will read “A_H1_Access, H1_S1_1, Free, Original Volume D”. After the sales referred to above and illustrated in FIG. 2, record 7 will contain the information appearing in FIG. 5B for originator A. Similar information will be stored in record 7 for the other hosts H2 and H3.

Likewise, originator D will have a record 7 for host H4, which in FIG. 6A shows the initial condition before any sales occur. It is clear that the total volume of the services S consumed or sold will eventually equal the original volume V.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments which are functional, mechanical or electrical equivalents of the specific embodiments and features that have been described and illustrated herein.

The embodiments of the invention in which an exclusive property or privilege is claimed are defined as follows:

1. A system for facilitating access by a plurality of consumers to services hosted on more than one originator, said system comprising:
in each originator, a host record storing host access information HAI for each consumer authorized to access a service hosted by the originator;
in a reseller for reselling services hosted by more than one originator, said reseller containing a reseller record storing host access information for each originator from which the reseller is authorized to access services, and, consumer access information for each consumer authorized to access services provided through the reseller;
wherein, in response to the reseller receiving information from an authorized consumer corresponding to the consumer access information for the authorized consumer, the reseller provides host access information from its reseller records to each originator hosting services the authorized consumer is authorized to access; and
wherein each originator receiving the host access information permits the authorized consumer access to the services for which the host access information received from the reseller corresponds with host access information stored in the host record of the originator.

2. The system as defined in claim 1 wherein one of the originators also comprises a reseller record storing host access information for services hosted by other originators from which the originator is authorized to access services, and, consumer access information for each consumer authorized to access services provided through or hosted by the originator;
wherein a consumer can access services hosted by the originator, or, provided through the originator and hosted by other originators, by providing to the originator information corresponding to the consumer access information stored in the originator.

3. The system as defined in claim 1 wherein at least one of the originators can deny the reseller authorization to access services by amending the corresponding access information stored in its host record for the reseller.

4. The system as defined in claim 3 wherein the host record of at least one of the originators contains information identifying consumers through which the reseller provides the services of the originator; and
wherein the at least one originator can deny consumers of the reseller authorization to access services provided through the reseller by amending the corresponding host record for the consumers of the reseller.

5. The system as defined in claim 4 wherein each originator comprises an agent associated with each service, said agent permitting access to the associated services if corresponding host access information is provided, said host access information comprising operating account information for each reseller and consumer of each reseller;
wherein each originator comprises a reseller record correlating the operating accounts of each consumer with the reseller through which the service is provided; and
wherein the at least one originator can deny unauthorized resellers and consumers of unauthorized resellers access to services provided through the reseller by amending the operating account information for the unauthorized reseller and the consumers of the unauthorized reseller.

6. The system as defined in claim 1 wherein the reseller can deny an unauthorized consumer authorization to access services provided through the reseller by amending the corresponding host access information for the unauthorized consumer.

7. The system as defined in claim 1 wherein the reseller is one of a plurality of resellers for reselling services hosted by more than one originator, each reseller containing a corresponding reseller record storing host access information for each originator from which the corresponding reseller is authorized to access resources, and, consumer access information for each consumer authorized to access resources provided through the corresponding reseller.

8. The system as defined in claim 7 wherein an authorized consumer of one reseller is identified by other resellers by a unique random identifier to maintain each consumer confidential.

9. The system as defined in claim 8 wherein at least one originator monitors and records billing information regarding access to the services the originator hosts; and
wherein the billing information identifies the consumer by its unique random identifier only.

10. The system as defined in claim 1 further comprising, in the reseller, a reseller volume record for storing volume information regarding volume of services available from each originator from which the reseller is authorized to access services, and, regarding volume of services having been committed by the reseller to others.

11. The system as defined in claim 1 wherein each originator hosts services on a corresponding host machine, said host machine having a unique address in a network; and
wherein the host access information comprises the address for the host machine hosting the corresponding service such that the reseller can send the host access information directly to the host machine.

12. The system as defined in claim 11 wherein each host machine has an associated agent, said associated agent receiving the host access information from the reseller and comparing the received host access information with the host access information stored in the host record.

13. The system as defined in claim 11 further comprising intermediate resellers for reselling services from originators to the reseller; and
wherein the host access information comprises the address for the host machine from which the intermediate reseller obtains the services such that the reseller can send the host access information directly to the host machine.

14. A method for facilitating access by a plurality of consumers to services hosted on more than one originator, said method comprising the steps of:
(a) for each originator, providing a host record storing host access information for each consumer authorized to access a service hosted by the originator;
(b) at a reseller, determining which services an authorized consumer is authorized to access; and
(c) sending host access information from the reseller to each originator hosting services the authorized consumer is authorized to access.

15. The method of claim 14 wherein step (b) comprises the substeps of:
(i) at the reseller, receiving consumer information from an authorized consumer; and
(ii) searching reseller records contained at the reseller to determine the services which the consumer is authorized to access.

16. The method of claim 15 comprising the preliminary step of comparing the information received by the reseller from the consumer to consumer access information stored by the reseller to determine if the information corresponds to consumer access information from an authorized consumer and identifying the authorized consumer.

17. The method as defined in claim 14 further comprising the steps of:
for each host machine of each originator, providing a unique address in a network; and
step (b) comprising the step of determining the unique address of each host machine hosting services the authorized consumer is authorized to access; and
sending the host access information directly to the unique address of each host machine hosting services the authorized consumer is authorized to access.

18. A virtual originator for providing consumers with access to services hosted by host machines contained in more than one actual originator, said virtual originator comprising:
reseller records storing host access information for each authorized consumer associated with the virtual originator;
a network interface connected to said reseller record sending and receiving information to said actual originator;
wherein, upon authorization of a consumer, host access information for said authorized consumer is located in said reseller record and sent through the network interface to said actual originators; and
wherein, upon receipt of the host access information, said actual originators permit the authorized consumer access to the services.

19. A virtual originator as claimed in claim 18 wherein the access to the services is provided through a graphical user interface generated by the virtual originator.

20. A virtual originator as claimed in claim 18 further comprising:
a local host machine for hosting at least one service, said local host machine receiving information from said reseller record; and
wherein, upon authorization of a consumer, if said consumer is authorized to access the least one service one the local host machine, the reseller record sends the host access information to the local host machine; and
wherein, upon receipt of the host access information, said local host machine permits the authorized consumer access to the at least one service.
